(19) United States
(12) Patent Application Publication
(10) Pub. No.: US 2026/0004967 A1
(43) Pub. Date: Jan. 1, 2026

(54) INTEGRATED ELECTRONIC COMPONENT AND RESONANT CONVERTER CIRCUIT

(71) Applicant: LITE-ON TECHNOLOGY CORPORATION, TAIPEI CITY (TW)

(72) Inventors: Chi-Yuan FENG, Taipei City (TW); Chen CHEN, Taipei City (TW); De-Jia LU, Taipei City (TW); Yong-Long SYU, Taipei City (TW); Kai-De CHEN, Taipei City (TW)

(21) Appl. No.: 19/225,073

(22) Filed: Jun. 2, 2025

Related U.S. Application Data
(60) Provisional application No. 63/665,503, filed on Jun. 28, 2024.

(30) Foreign Application Priority Data
Apr. 14, 2025 (TW) 114113989

(51) Int. Cl. H01F 27/34; H01F 27/24; H01F 27/28; H02M 3/00; H02M 3/335

(52) U.S. Cl. CPC H01F 27/346; H01F 27/24; H01F 27/28; H02M 3/01; H02M 3/335

(57) ABSTRACT

An integrated electronic component for a converter is provided. The integrated electronic component includes a magnetic core, a first primary side winding, a second primary side winding, a first secondary side winding, and a second secondary side winding. The magnetic core has spacing configuration between a first pole and a second pole. The first pole and the second pole are located along a magnetic flux path. The first primary side winding and the first secondary side winding are wound around the first pole. The second primary side winding and the second secondary side winding are wound around the second pole. The first secondary side winding and the second secondary side winding are coupled to at least one first rectifier switch and at least one second rectifier switch, and on-time periods of the at least one first rectifier switch and the at least one second rectifier switch are different.

### CROSS REFERENCE TO RELATED APPLICATIONS

This application claims priority of Taiwan Patent Application No. 114113989, filed on Apr. 14, 2025, the entirety of which is incorporated by reference herein.

This application claims the benefit of U.S. Provisional Application No. 63/665,503, filed on Jun. 28, 2024, the entirety of which is incorporated by reference herein.

### BACKGROUND OF THE INVENTION

### Field of the Invention

The present invention relates to a resonant converter circuit, and in particular it relates to a resonant converter circuit and an integrated electronic component therein.

### Description of the Related Art

Current integrated transformers often require multiple poles for winding. Since the leakage inductance of an integrated transformer can affect the overall resonance inductance, a larger leakage inductance makes it easier to design the transformer. However, the current methods used to increase the leakage inductance are to increase the number of windings or to disrupt the coupling between the primary and secondary sides of the transformer, which results in higher winding losses. A new design is needed to solve these problems.

### BRIEF SUMMARY OF THE INVENTION

The present invention provides an integrated electronic component and resonant converter circuit, which can reduce the winding loss to increase the power conversion efficiency and enhance the effect of energy saving and carbon reduction.

According to an embodiment, the present invention provides an integrated electronic component for a converter. The integrated electronic component includes a magnetic core, a first primary side winding, a second primary side winding, a first secondary side winding, and a second secondary side winding. The magnetic core has spacing configuration between a first pole and a second pole, wherein the first pole and the second pole are located along a magnetic flux path. The first primary side winding and the first secondary side winding are wound around the first pole. The second primary side winding and the second secondary side winding are wound around the second pole. Wherein the first secondary side winding and the second secondary side winding are coupled to at least one first rectifier switch and at least one second rectifier switch, and on-time periods of the at least one first rectifier switch and the at least one second rectifier switch are different.

According to an embodiment, the integrated electronic component further includes a third pole, a first panel, and a second panel. The third pole is located along the magnetic flux path. The first pole and the second pole are located between the first panel and the second panel, and the first panel and the second panel are stacked along a first direction perpendicular to a second direction in which the first pole and the second pole are arranged. The first pole, the second pole, and the third pole are arranged along the second direction. Long axis of the third pole is extended along a third direction, and the third direction is perpendicular to the first direction and the second direction.

The integrated electronic component further includes at least one window, exposure direction of the at least one window is parallel to the third direction, which causes the first primary side winding, the second primary side winding, the first secondary side winding, and the second secondary side winding to be exposed.

According to an embodiment, the integrated electronic component further includes a fourth pole, wherein the first pole and the second pole are located between the third pole and the fourth pole, and the first pole, the second pole, the third pole, and the fourth pole are arranged along the second direction.

According to an embodiment, the first secondary side winding includes two first secondary side sub-windings, the second secondary side winding includes two second secondary side sub-windings. The two first secondary side sub-windings include a top first secondary side sub-winding and a bottom first secondary side sub-winding, wherein the top first secondary side sub-winding is located between the first primary side winding and the first panel, and the bottom first secondary side sub-winding is located between the first primary side winding and the second panel. The two second secondary side sub-windings include a top second secondary side sub-winding and a bottom second secondary side sub-winding, wherein the top second secondary side sub-winding is located between the second primary side winding and the first panel, and the bottom second secondary side sub-winding is located between the second primary side winding and the second panel. The two first secondary side sub-windings are connected through a plurality of first conductive vias and coupled to an output load circuit, and the two second secondary side sub-windings are connected through a plurality of second conductive vias and coupled to the output load circuit.

According to an embodiment, the present invention provides a resonant converter circuit. The resonant converter circuit includes a power supply, the integrated electronic component, a primary side circuit, and a secondary side circuit. The primary side circuit is coupled between the power supply and the integrated electronic component. The secondary side circuit is coupled between the integrated electronic component and a ground terminal. The primary side circuit includes a half bridge switch, and the half bridge switch includes a first switch and a second switch. The first switch is coupled between the power supply and a first node, and the second switch is coupled between the first node and the ground terminal. The integrated electronic component further includes a resonant circuit. The resonant circuit is coupled between the first node and the ground terminal, and has a resonant capacitor, an excitation inductor, and a resonant inductor coupled in series. The secondary side circuit includes a rectifier circuit, and the output load circuit. The rectifier circuit is coupled between the first secondary side winding and the second secondary side winding, and has the two first rectifier switches and the two second rectifier switches. The output load circuit is configured to output an output current.

The first switch and the two first rectifier switches are ON and the second switch and the two second rectifier switches are OFF, during a positive half cycle. The first switch and the two first rectifier switches are OFF and the second switch and the two second rectifier switches are ON, during a negative half cycle.

### BRIEF DESCRIPTION OF THE DRAWINGS

FIG. 1 is a circuit diagram of a resonant converter circuit according to an embodiment of the present invention.

FIG. 2 is a structural diagram of an integrated electronic component according to an embodiment of the present invention.

FIG. 3 is a structural diagram of an integrated electronic component according to an embodiment of the present invention.

FIG. 4A and FIG. 4B are schematic diagrams of the integrated electronic component of FIG. 2 at different angles.

FIG. 5A and FIG. 5B are schematic diagrams of the integrated electronic component of FIG. 3 at different angles.

FIG. 6A is a magnetoresistive model of an integrated electronic component at a positive half cycle according to an embodiment of the present invention.

FIG. 6B is a magnetoresistive model of an integrated electronic component at a negative half cycle according to an embodiment of the present invention.

### DETAILED DESCRIPTION OF THE INVENTION

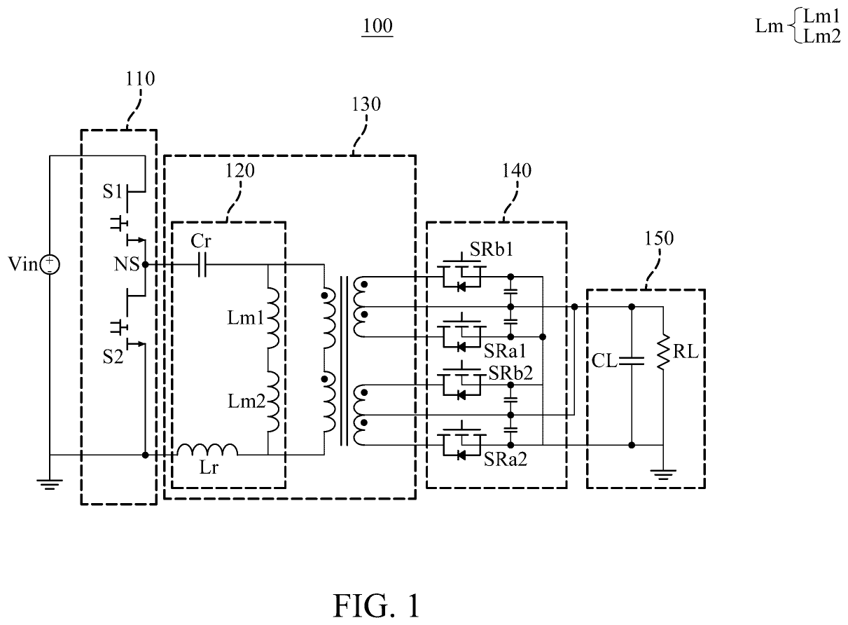

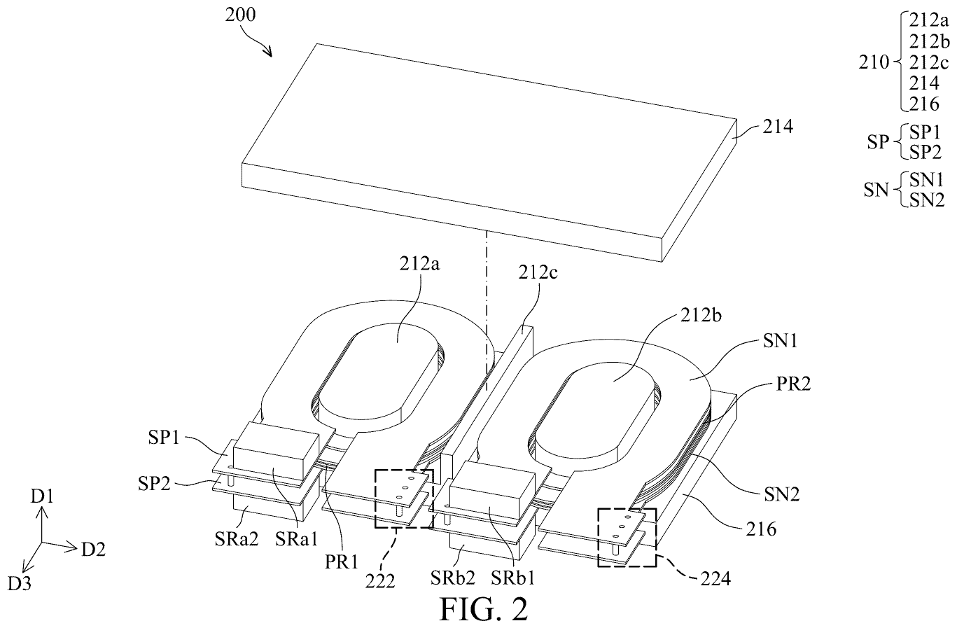

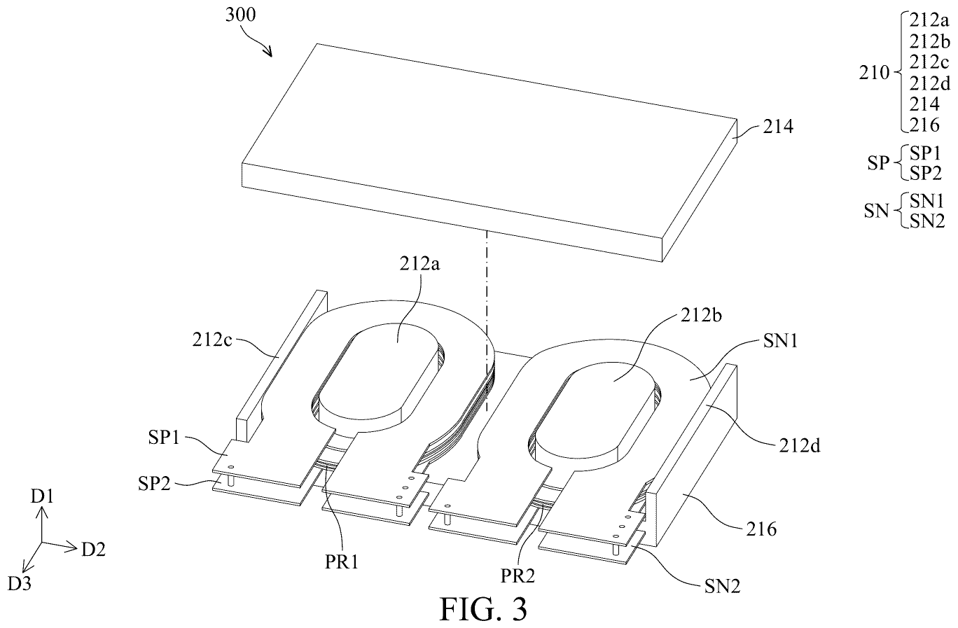

FIG. 1 is a circuit diagram of a resonant converter circuit 100 according to an embodiment of the present invention. The resonant converter circuit 100 includes a switching circuit 110, a resonant circuit 120, an integrated electronic component 130, a rectifier circuit 140, and an output load circuit 150. The primary side circuit of the resonant converter circuit 100 includes the switching circuit 110. The switching circuit 110 includes a power supply Vin for providing an input voltage, and switches S1 and S2 coupled to each other in series. The switch S1 is coupled between the power supply Vin and a node NS, and the switch S2 is coupled between the node NS and a ground terminal. The integrated electronic component 130 includes the resonant circuit 120. The resonant circuit 120 includes a resonant capacitor Cr, a resonant inductor Lr, and an excitation inductor Lm coupled in series. The excitation inductor Lm further includes excitation inductors Lm1 and Lm2. In addition, the resonant circuit 120 is coupled between the node NS and the ground terminal. The integrated electronic component 130 will be described below with reference to FIGS. 2 and 3.

The secondary side circuit of the resonant converter circuit 100 includes the rectifier circuit 140 and the output load circuit 150. The rectifier circuit 140 is coupled between the integrated electronic component 130 and the output load circuit 150. The rectifier circuit 140 includes rectifier switches SRa1, SRa2, SRb1, and SRb2. The rectifier switches SRa1, SRa2 and the rectifier switches SRb1, SRb2 have different on-time periods. That is, the rectifier switches SRa1 and SRa2 are ON, while the rectifier switches SRb1 and SRb2 are OFF. Conversely, the rectifier switches SRb1 and SRb2 are ON, while the rectifier switches SRa1 and SRa2 are OFF. The output load circuit 150 includes a load capacitor CL and a load resistor RL, and is configured to receive an output current from the rectifier circuit 140.

During a positive half cycle, the switch S1 is ON and switch S2 is OFF, which causes the current to flow into the integrated electronic component 130. At this time, in order to cause the current to flow out to the output load circuit 150, the rectifier switches SRa1 and SRa2 are ON and rectifier switches SRb1 and SRb2 are OFF. During a negative half cycle, the switch S2 is ON and switch S1 is OFF, which causes the current to flow out of the integrated electronic component 130. At this time, in order to cause the current to flow out to the output load circuit 150, the rectifier switches SRb1 and SRb2 are ON and rectifier switches SRa1 and SRa2 are OFF.

FIGS. 2 and 3 illustrate multiple examples of the integrated electronic component 130, respectively. FIG. 2 illustrates a structural diagram of an integrated electronic component 200. The integrated electronic component 200 includes a magnetic core 210, primary side windings PR1 and PR2 coupled in series with each other, secondary side windings SP and SN, and a leakage inductance pole 212c. The magnetic core 210 includes magnetic poles 212a, 212b, and flat panels 214, 216. The primary side winding PR1 and secondary side winding SP are wound above the magnetic poles 212a, and the primary side winding PR2 and secondary side winding SN are wound above the magnetic poles 212b. The magnetic poles 212a, 212b, and the leakage inductance pole 212c are arranged in a direction D2. The leakage inductance pole 212c is located between the magnetic poles 212a and 212b, and the magnetic poles 212a, 212b and the leakage inductance pole 212c are located on the same magnetic flux path. The flat panels 214 and 216 are stacked along a direction D1 and the directions D1 and D2 are perpendicular to each other. In addition, the secondary side winding SP is located on both the upper and lower (i.e., direction D1) sides of the primary side winding PR1. Similarly, the secondary side winding SN is located on both the upper and lower sides of the primary side winding PR2.

The secondary side winding SP includes a top secondary side sub-winding SP1 and a bottom secondary side sub-winding SP2. The top secondary side sub-winding SP1 is located between the primary side winding PR1 and the flat panel 214, and the bottom secondary side sub-winding SP2 is located between the primary side winding PR1 and the flat panel 216. In addition, the top secondary side sub-winding SP1 and the bottom secondary side sub-winding SP2 are coupled in parallel through the conductive via 222, and the rectifier switch SRa1 is coupled to the top secondary side sub-winding SP1 and the rectifier switch SRa2 is coupled to the bottom secondary side sub-winding SP2. Similarly, the secondary winding SN includes a top secondary sub-winding SN1 and a bottom secondary sub-winding SN2, and the top secondary sub-winding SN1 is located between the primary winding PR1 and the flat plate 214, and the bottom secondary sub-winding SN2 is located between the primary winding PR1 and the flat plate 216. Similarly, the secondary side winding SN includes a top secondary side sub-winding SN1 and a bottom secondary side sub-winding SN2. The top secondary side sub-winding SN1 is located between the primary side winding PR2 and the flat panel 214, and the bottom secondary side sub-winding SN2 is located between the primary side winding PR2 and the flat panel 216. In addition, the top secondary side sub-winding SN1 and the bottom secondary side sub-winding SN2 are coupled in parallel through the conductive via 224, and the rectifier switch SRb1 is coupled to the top secondary side sub-winding SN1 and the rectifier switch SRb2 is coupled to the bottom secondary side sub-winding SN2.

Since the rectifier switches SRa1, SRa2 and the rectifier switches SRb1, SRb2 have different on-time periods, the periods during which the current flows through the secondary side windings SP and SN are different. Therefore, when the primary side windings PR1 and PR2 have the same number of windings (i.e., the primary side magnetic flux generated on the magnetic poles 212a and 212b is the same), by controlling the number of windings of the secondary side windings SP and SN, the integrated electronic component 200 can generate the magnetic flux of the leakage inductance on the leakage inductance pole 212c by causing the current to flow through the different secondary side windings during different periods. In addition, referring to FIGS. 1 and 2, the magnetic pole of one winding corresponds to one set of excitation inductance and one set of rectifier circuits so that the two magnetic poles 212a and 212b correspond to the excitation inductors Lm1, Lm2 and two sets of rectifier circuits with different half cycles (one set of rectifier switch SRa1, SRa2, and one set of rectifier switch SRb1, SRb2). The leakage inductance pole 212c corresponds to the resonant inductor Lr. More specifically, this embodiment uses the leakage inductance of the integrated electronic component itself as the resonant inductance.

FIG. 3 is a structural diagram of an integrated electronic component 300 according to an embodiment of the present invention. Similar to the integrated electronic component 200, the integrated electronic component 300 includes the magnetic core 210, the primary side windings PR1 and PR2 coupled in series with each other, and the secondary side windings SP and SN. The difference between the integrated electronic components 200 and 300 is that the integrated electronic component 300 further includes a leakage inductance pole 212d and the leakage inductance pole 212c is located at a different position. Specifically, the magnetic poles 212a and 212b are located between the leakage inductance poles 212c and 212d. The magnetic poles 212a and 212b and the leakage inductance poles 212c and 212d are aligned in the direction D2 and are located on the same magnetic flux path. In addition, similar to the integrated electronic component 200, the integrated electronic component 300 has the top secondary sub-winding SP1 and the bottom secondary sub-winding SP2 coupled to the rectifier switches SRa1 and SRa2 (not shown in FIG. 3), respectively. The top secondary sub-winding SN1 and the bottom secondary sub-winding SN2 are coupled to the rectifier switches SRb1 and SRb2 (not shown in FIG. 3), respectively.

The rectifier switches SRa1, SRa2 and the rectifier switches SRb1, SRb2 have different on-time periods. Therefore, when the primary side windings PR1 and PR2 have the same number of windings, by controlling the number of windings of the secondary side windings SP and SN, the integrated electronic component 300 can generate the magnetic flux of the leakage inductance on the leakage inductance poles 212c and 212d by causing the current to flow through the different secondary side windings during different periods. In addition, referring to FIGS. 1 and 3, the two magnetic poles 212a and 212b correspond to the excitation inductors Lm1, Lm2 and two sets of rectifier circuits with different half cycles (one set of rectifier switches SRa1, SRa2, and one set of rectifier switches SRb1, SRb2). The leakage inductance poles 212c and 212d correspond to the resonant inductor Lr.

With the integrated electronic components 200 and 300, the required leakage inductance can be achieved without increasing the number of the existing magnetic poles (i.e., only using the magnetic poles 212a and 212b) by wounding the secondary side windings SP and SN of different half cycles (e.g., positive half cycle and negative half cycle) around the different magnetic poles, and making the rectifier switches SRa1, SRa2 and the rectifier switches SRb1, SRb2 ON in different time periods.

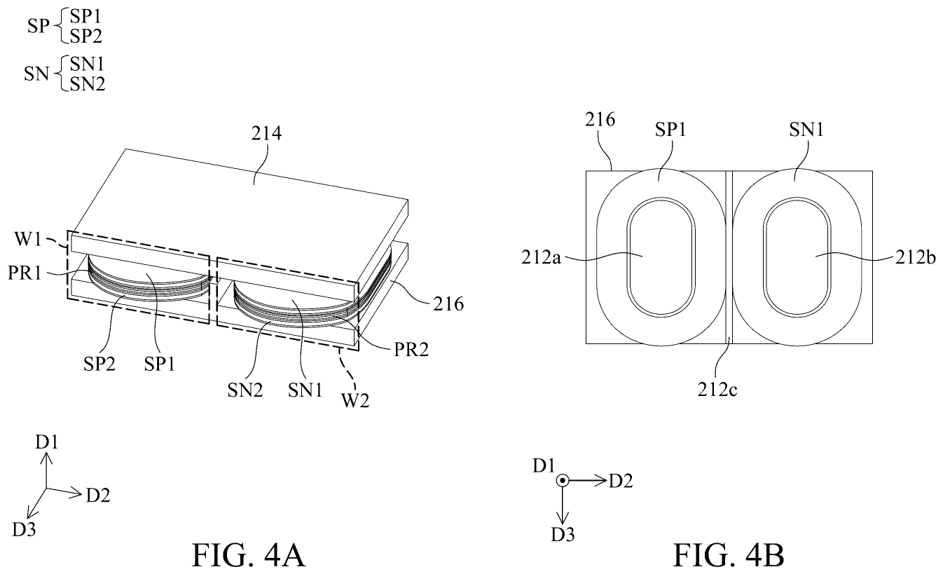

FIGS. 4A and 4B are schematic diagrams of the integrated electronic component 200 of FIG. 2 at different angles. Referring to FIG. 4A, the rectifier switches SRa1, SRa2, SRb1, and SRb2 are not shown for simplicity and clarity. Since the leakage inductance pole 212c is located between the magnetic poles 212a and 212b, the integrated electronic component 200 has windows on both sides in the direction D2 (i.e., the direction in which the magnetic poles 212a, 212b, and the leakage inductance pole 212c are arranged). In addition, in a direction D3 perpendicular to the directions D1 and D2, the integrated electronic component 200 also has windows W1 and W2 such that the primary side windings PR1, PR2 and the secondary side windings SP, SN are exposed. That is, the direction of exposure of the windows W1 and W2 is parallel to the direction D3. Next, referring to FIG. 4B, FIG. 4B illustrates a schematic diagram of the integrated electronic component 200 looking down from the direction D1. For ease of description, the rectifier switches SRa1, SRa2, SRb1, SRb2, and the flat panel 214 are not depicted. As shown in the drawing, the long axes of the cross-section of the magnetic poles 212a and 212b extend along the direction D3 perpendicular to the directions D1 and D2, and the long axis of the leakage inductance pole 212c also extends along the direction D3.

Although FIG. 4A only illustrates the windows W1 and W2 on one side, the integrated electronic component 200 has windows on both sides in direction D3 as shown in FIG. 4B. Therefore, airflow can pass through the integrated electronic component 200 along the direction D3 from the windows W1 and W2 on one side and flow out of the windows W1 and W2 on the other side so that the magnetic poles 212a, 212b, and the leakage inductance pole 212c can be in contact with the airflow, which results in a higher heat dissipation efficiency.

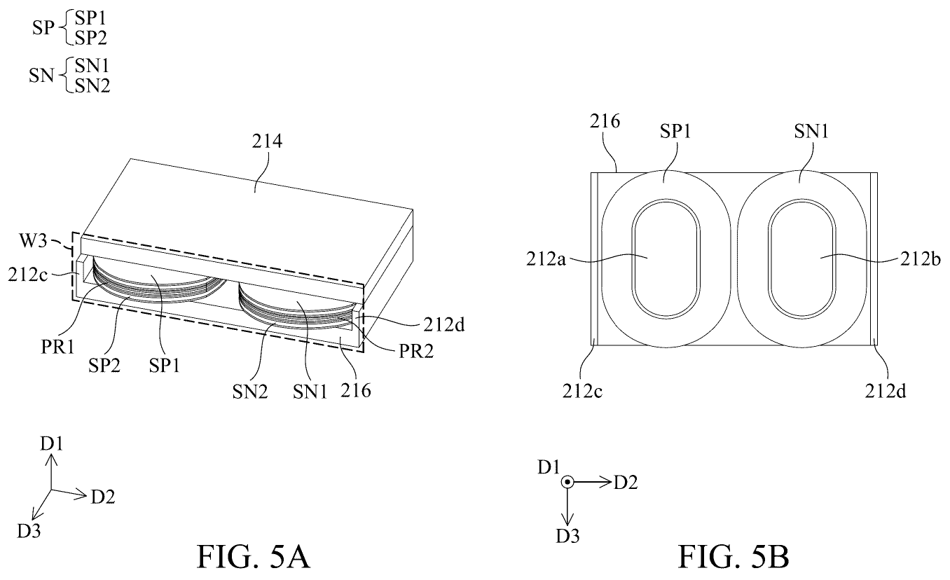

FIGS. 5A and 5B are schematic diagrams of the integrated electronic component 300 of FIG. 3 at different angles. Similar to FIGS. 4A and 4B, some elements are not shown for the purpose of simplicity, clarity and ease of illustration. Referring to FIG. 5A, since the magnetic poles 212a and 212b are located between the leakage inductance poles 212c and 212d, the integrated electronic component 300 does not have window on either side in the direction D2. The integrated electronic component 300 has a window W3 in the direction D3. Next, referring to FIG. 5B, FIG. 5B illustrates a schematic diagram of the integrated electronic component 300 looking down from the direction D1. The long axes of the cross-section of the magnetic poles 212a and 212b extend along the direction D3 perpendicular to the directions D1 and D2, and the long axes of the leakage inductance poles 212c and 212d also extend along the direction D3.

Although FIG. 5A only illustrates the window W3 on one side, the integrated electronic component 300 has windows on both sides in the direction D3 as shown in FIG. 5B. Therefore, airflow can pass through the integrated electronic component 300 from the window W3 on one side and flow out of the window W3 on the other side along the direction D3 so that the magnetic poles 212a, 212b, and the leakage inductance poles 212c, 212d can be in contact with the airflow, which results in a higher heat dissipation efficiency.

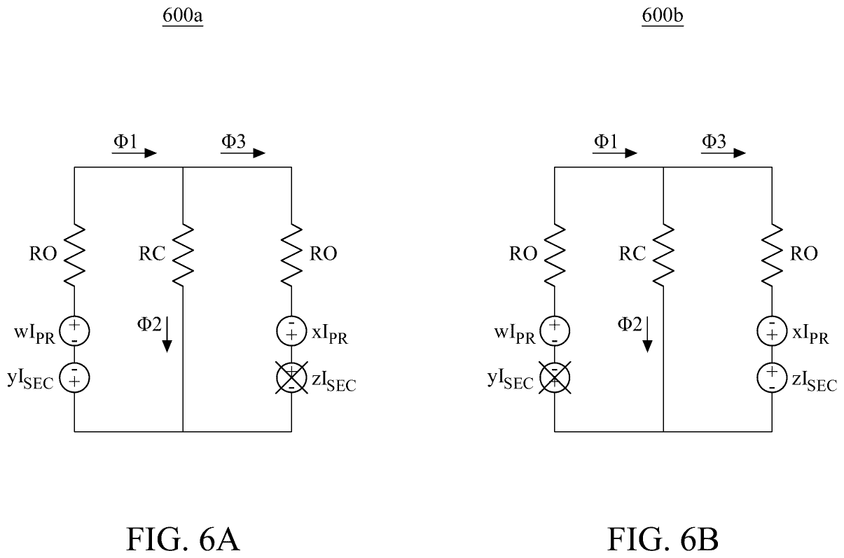

FIGS. 6A and 6B illustrate magnetoresistive models 600a and 600b, respectively, using integrated electronic component 200 as an example. According to the structure of the integrated electronic component 200, the following equations may be set forth:

$$Φ 1 = \frac{w \times R O + ( x + w ) \times R C}{R O \times ( R O + 2 \times R C )} \times {I}_{PR} - \frac{y \times R O + ( y + z ) \times R C}{R O \times ( R O + 2 \times R C )} \times {I}_{S E C} \qquad equation ( 1 )$$

$$Φ2 = \frac{( w - x )}{RO + 2 \times R C} \times {I}_{PR} - \frac{( z - y )}{R O + 2 \times R C} \times {I}_{SE C} \qquad equation ( 2 )$$

$$Φ3 = \frac{x \times R O + ( x + w ) \times R C}{R O \times ( R O + 2 \times R C )} \times {I}_{PR} - \frac{z \times R O + ( y + z ) \times R C}{R O \times ( R O + 2 \times R C )} \times {I}_{S E C} \qquad equation ( 3 )$$

where Φ1 and Φ3 are the magnetic fluxes of the magnetic poles 212a and 212b, respectively, and Φ2 is the magnetic flux of the leakage inductance pole 212c. w and x represent the winding turns of the primary side windings PR1 and PR2, respectively, and y and z represent the winding turns of the secondary side windings SP and SN, respectively. I_{PR} represents the current flowing through the primary side windings PR1 and PR2, and I_{SEC} represents the current flowing through the secondary side windings SP and SN. RO is the magnetic reluctance of the magnetic poles 212a and 212b, and RC is the magnetic reluctance of the leakage inductance pole 212c. According to equation (2), it can be deduced that by controlling the number of turns w, x, y, and z (i.e., by assigning the appropriate number of winding turns to the magnetic poles 212a and 212b), the magnetic flux of leakage inductance pole Φ2 of the integrated electronic component 200 can be controlled.

Referring to FIG. 6A, FIG. 6 illustrates a magnetoresistive model 600a for a positive half cycle. Since the rectifier switches SRb1 and SRb2 are OFF during the positive half cycle, there is no current flow through the secondary side winding SN on the magnetic pole 212b (cross mark as shown in FIG. 6A). In this case, the equation (2) can be rewritten as follows:

$$Φ2 = \frac{( w - x )}{RO + 2 \times R C} \times {I}_{P R} + \frac{y}{R O + 2 \times R C} \times {I}_{SE C} \qquad equation ( 4 )$$

Next, referring to FIG. 6B, FIG. 6B illustrates a magnetoresistive model 600b for a negative half cycle. Since the rectifier switches SRa1 and SRa2 are OFF during the negative half cycle, there is no current flow through the secondary side winding SP on the magnetic pole 212a (cross mark as shown in FIG. 6B). In this case, the equation (2) can be rewritten as follows:

$$Φ2 = \frac{( w - x )}{RO + 2 \times R C} \times {I}_{PR} - \frac{z}{R O + 2 \times R C} \times {I}_{SE C} \qquad equation ( 5 )$$

Comparing the equations (4) and (5), if the magnetic fluxes of leakage inductance pole Φ2 of the positive half cycle and the negative half cycle are equal, then w=x and y=z. That is, when the number of turns of the primary side winding PR1 is the same as the number of turns wound around the primary side winding PR2, and the number of turns of the secondary side winding SP is the same as the number of turns of the secondary side winding SN, the leakage inductance of the integrated electronic component 200 is the same at the positive half cycle and the negative half cycle. In addition, by controlling the cross-sectional areas of the magnetic poles 212a, 212b, and leakage inductance pole 212c (and leakage inductance pole 212d as well), the leakage inductance can be affected to reduce the size of the resonant converter circuit 100 by integrating the resonant inductor Lr and the excitation inductance Lm.

The present invention provides a resonant converter circuit including a power supply, a primary side circuit, an integrated electronic component, and a secondary side circuit. The primary side circuit is coupled between the power supply and the integrated electronic component, and the integrated electronic component is coupled between the primary side circuit and the secondary side circuit. The primary side circuit includes a half bridge switch and a resonant circuit. The half bridge switch includes switches S1 and S2 coupled in series with each other. The resonant circuit includes a resonant capacitor Cr, excitation inductors Lm1 and Lm2, and a resonant inductor Lr coupled in series. The secondary side circuit includes a rectifier circuit and an output load circuit. The rectifier circuit includes rectifier switches SRa1, SRa2, SRb1, and SRb2. The output load circuit includes a load resistor RL and a load capacitor CL.

The present invention provides the integrated electronic component including a magnetic core, a primary side winding, and a secondary side winding. The magnetic core includes magnetic poles 212a and 212b. The primary side winding is wound around the magnetic poles 212a and 212b with the same number of turns, and the secondary side winding is also wound around the magnetic poles 212a and 212b with the same number of turns. The rectifier switches SRa1 and SRa2 are coupled to the secondary side winding wound around the magnetic pole 212a, and the rectifier switches SRb1 and SRb2 are coupled to the secondary side winding wound around the magnetic pole 212b. In this manner, by the characteristics of the rectifier switches SRa1, SRa2 and the rectifier switches SRb1, SRb2 that turn ON at different half cycles, the on-time of the switches and the number of winding turns can be allocated to achieve the desired leakage inductance of the integrated electronic component without the need for additional magnetic poles (i.e., poles for winding). In addition, by arranging the magnetic poles and the leakage inductance poles of the integrated electronic components 200 and 300 as illustrated in FIGS. 4A and 5A, the airflow can be routed through the windows W1, W2, or W3 on both sides to achieve the effect of dissipating the heat of each of the magnetic poles and the leakage inductance poles.

What is claimed is:

1. An integrated electronic component for a converter, wherein the integrated electronic component comprises:
a magnetic core, having spacing configuration between a first pole and a second pole, wherein the first pole and the second pole are located along a magnetic flux path;
a first primary side winding, wound around the first pole;
a second primary side winding, wound around the second pole;
a first secondary side winding, wound around the first pole; and
a second secondary side winding, wound around the second pole;
wherein the first secondary side winding and the second secondary side winding are respectively coupled to at least one first rectifier switch and at least one second rectifier switch;
wherein on-time periods of the at least one first rectifier switch and the at least one second rectifier switch are different.

2. The integrated electronic component as claimed in claim 1, further comprising:
a third pole, located along the magnetic flux path; and
a first panel and a second panel, wherein the first pole and the second pole are located between the first panel and the second panel, and the first panel and the second panel are stacked along a first direction perpendicular to a second direction in which the first pole and the second pole are arranged.

3. The integrated electronic component as claimed in claim 2, wherein the third pole is located between the first pole and the second pole, and the first pole, the second pole, and the third pole are arranged along the second direction.

4. The integrated electronic component as claimed in claim 2, further comprising a fourth pole, wherein the first pole and the second pole are located between the third pole and the fourth pole, and the first pole, the second pole, the third pole, and the fourth pole are arranged along the second direction.

5. The integrated electronic component as claimed in claim 2, wherein:
long axis of the third pole is extended along a third direction, and the third direction is perpendicular to the first direction and the second direction; and
the integrated electronic component further comprises at least one window, exposure direction of the at least one window is parallel to the third direction, which causes the first primary side winding, the second primary side winding, the first secondary side winding, and the second secondary side winding to be exposed.

6. The integrated electronic component as claimed in claim 2, wherein long axis of the first pole and long axis of the second pole are extended along a third direction, and the third direction is perpendicular to the first direction and the second direction.

7. The integrated electronic component as claimed in claim 2, wherein the first secondary side winding comprises two first secondary side sub-windings, the second secondary side winding comprises two second secondary side sub-windings.

8. The integrated electronic component as claimed in claim 7, wherein the two first secondary side sub-windings are arranged on both sides of the first primary side winding, the two second secondary side sub-windings are arranged on both sides of the second primary side winding.

9. The integrated electronic component as claimed in claim 7, wherein:
the two first secondary side sub-windings comprise a top first secondary side sub-winding and a bottom first secondary side sub-winding, wherein the top first secondary side sub-winding is located between the first primary side winding and the first panel, and the bottom first secondary side sub-winding is located between the first primary side winding and the second panel; and
the two second secondary side sub-windings comprise a top second secondary side sub-winding and a bottom second secondary side sub-winding, wherein the top second secondary side sub-winding is located between the second primary side winding and the first panel, and the bottom second secondary side sub-winding is located between the second primary side winding and the second panel.

10. The integrated electronic component as claimed in claim 7, wherein the two first secondary side sub-windings are connected through a plurality of first conductive vias and coupled to an output load circuit, and the two second secondary side sub-windings are connected through a plurality of second conductive vias and coupled to the output load circuit.

11. The integrated electronic component as claimed in claim 7, further comprising a rectifier circuit, wherein:
the rectifier circuit comprises two first rectifier switches and two second rectifier switches;
one of the two first rectifier switches is coupled to one of the two first secondary side sub-windings;
the other of the two first rectifier switches is coupled to the other of the two first secondary side sub-windings;
one of the two second rectifier switches is coupled to one of the two second secondary side sub-windings; and
the other of the two second rectifier switches is coupled to the other of the two second secondary side sub-windings.

12. The integrated electronic component as claimed in claim 11, further comprising a resonant circuit, wherein the resonant circuit comprises a resonant capacitor, an excitation inductor, and a resonant inductor coupled in series.

13. The integrated electronic component as claimed in claim 12, further comprising:
a switching circuit, having a first switch and a second switch coupled in series, wherein the first switch and the second switch are connected in series through a first node, and the resonant circuit is coupled between the first node and a ground terminal; and
an output load circuit, coupled to the rectifier circuit, and configured to output an output current from the rectifier circuit.

14. The integrated electronic component as claimed in claim 13, wherein:
the two first rectifier switches and the first switch are ON and the second switch and the two second rectifier switches are OFF, during a positive half cycle; and
the first switch and the two first rectifier switches are OFF and the second switch and the two second rectifier switches are ON, during a negative half cycle.

15. The integrated electronic component as claimed in claim 1, further comprising a resonant circuit, wherein the resonant circuit comprises a resonant capacitor, an excitation inductor, and a resonant inductor coupled in series, the excitation inductor comprises the first pole and the second pole, the resonant inductor comprises a third pole, and the first pole, the second pole, and the third pole are located along the magnetic flux path.

16. The integrated electronic component as claimed in claim 1, wherein the first primary side winding and the second primary side winding are coupled in series.

17. The integrated electronic component as claimed in claim 1, wherein the first primary side winding and the second primary side winding have the same number of turns.

18. A resonant converter circuit, comprising:
a power supply;
the integrated electronic component as claimed in claim 1;
a primary side circuit, coupled between the power supply and the integrated electronic component; and
a secondary side circuit, coupled between the integrated electronic component and a ground terminal.

19. The resonant converter circuit as claimed in claim 18, wherein:
the integrated electronic component further comprises a resonant circuit, and the resonant circuit is coupled between a first node and the ground terminal, and has a resonant capacitor, an excitation inductor, and a resonant inductor coupled in series;
the primary side circuit comprises a half bridge switch, and the half bridge switch comprises a first switch and a second switch, wherein the first switch is coupled between the power supply and the first node, and the second switch is coupled between the first node and the ground terminal;
the secondary side circuit comprises:
a rectifier circuit, coupled between a first secondary side winding and a second secondary side winding, and having two first rectifier switches and two second rectifier switches; and
an output load circuit, configured to output an output current;
the first switch and the two first rectifier switches are ON and the second switch and the two second rectifier switches are OFF, during a positive half cycle; and
the first switch and the two first rectifier switches are OFF and the second switch and the two second rectifier switches are ON, during a negative half cycle.

20. The resonant converter circuit as claimed in claim 19, wherein the excitation inductor comprises a first pole and a second pole, the resonant capacitor comprises a third pole, and the first pole, the second pole, and the third pole are located along a magnetic flux path.
